(19) United States
(12) Patent Application Publication
(10) Pub. No.: US 2025/0009493 A1
(43) Pub. Date: Jan. 9, 2025

(54) DEVICE AND METHOD FOR DETERMINING THE POSITION OF A DENTAL IMPLANT

(71) Applicant: INSTITUT STRAUMANN AG, Basel (CH)

(72) Inventors: Leif SVENSSON, Parramatta (AU); Vincenzo SORRENTINO, Parramatta (AU); Kevin Frederick CHOU, Parramatta (AU)

(21) Appl. No.: 18/708,762

(22) PCT Filed: Sep. 28, 2022
(86) PCT No.: PCT/AU2022/051159

§ 371 Date: May 9, 2024

(30) Foreign Application Priority Data
Nov. 9, 2021 (AU) 2021903572

(51) Int. Cl. A61C 19/00

(52) U.S. Cl. CPC A61C 19/00

(57) ABSTRACT

A device for use in determining the position (location and/or orientation) of at least one dental implant, the device comprising a central body with an attachment portion adapted to attach to the dental implant. One or more arms extend away from the central body of the device and are adapted to bond to at least one other device. In particular, the one or more arms of the device bond to the central body and/or one or more arms of another device.

### FIELD OF THE INVENTION

The present invention relates generally to a device and method, in particular a device and method for use in determining the position of at least one dental implant.

### BACKGROUND OF THE INVENTION

Tooth loss is a common issue which typically results in the use of a prosthetic (fixed or removable). When one or more teeth are lost, a patient can undergo a surgical procedure to implant one or more dental implants into their jaw. These dental implants are fixed to the jaw such that they can receive a dental prosthetic for everyday use.

The precise location of the dental implants within the mouth generally differ between patients as the size and shape of each patient's mouth is unique. The unique location of each dental implant is gathered to create the dental prosthetic to ensure the prosthetic is comfortable, has long term stability by not putting undue pressure on the jaw, and a reduced risk of bacterial infection of the gums as a result of general use of the dental prosthetic.

To create a dental prosthetic, an impression of the gums and the dental implants is required. Historically, these impressions were gathered by using polysiloxane putty, light body and impression trays to create physical impressions of a patient's mouth. While effective, this process was quite uncomfortable for the patient, required numerous materials, a large amount of time, and had high material cost. As such, a new impression method is used wherein an intraoral dental scanner obtains a digital impression of the mouth. These digital impressions are more accurate, require significantly less time and require the use of an intraoral scanner and scan flags (or bodies).

To obtain a digital impression of the dental implants, scan flags are first attached to the dental implants. An intraoral scanner then scans the patient's mouth, including the scan flags and uses the location of the scan flags to obtain precise information on the orientation and position of the dental implants. Scan flags that are known in the art are typically long straight bodies which are inserted onto the dental implants. However, they do not take the contours and curves of the mouth into consideration, limiting their accuracy. Further, they are likely to be mispositioned in the event the patient moves their mouth or is bumped, reducing the accuracy of the scan, and in some instances requiring the practitioner to perform a second scan.

Once the scan flags are registered by the intraoral scanner and information on the orientation and position of the dental implant is obtained, this information is used to create a verification jig which confirms the accuracy of the impression. At the verification appointment, the jig is utilised to confirm that the impression was indeed accurate or not. This is established by seating the jig over the implants to confirm their passive nature in relation to the implants. If the verification jig is found not be seated passively over the implants, then it is cut into sections and bonded and sent back to the lab for model manipulation according to the mouth modified and verified appliance. Following the verification appointment, the practitioner will complete an MMR (maxilla mandibular record) appointment to establish the relationship of the top and bottom jaw to allow the lab to ascertain where the ideal tooth placement should be. A practitioner may opt to do one final trial fitting with the teeth in a temporised format or give instruction to a laboratory to complete the case for the patient.

It would be advantageous if there were provided a device and/or method that increased the accuracy of the location and/or orientation data of a dental implant obtained by digital impression, and/or a method that removed the need for additional verification jig appointments.

It is an object of the present invention to overcome or ameliorate at least one of the disadvantages of the prior art.

### SUMMARY OF THE INVENTION

In accordance with a first aspect of the invention, there is provided a device for use in determining a position of at least one dental implant, the device comprising: a central body with an attachment portion adapted to attach to the dental implant; one or more arms extending away from the central body; and wherein the one or more arms are adapted to bond to at least one other device.

In an embodiment, the central body removably receives the one or more arms.

In an embodiment, the one or more arms are received by the central body by way of a collar from which the one or more arms extend.

In an embodiment, at least one of the one or more arms of the device bond to the at least one other devices central body or one or more arms.

In an embodiment, the device further comprises one or more channels located on the one or more arms; and wherein a bonding material is adapted to be received in the one or more channels to bond at least one of the one or more arms of the device to the at least one other device.

In an embodiment, the device further comprises one or more holes on at least one of the one or more arms.

In an embodiment, the one or more arms of the device comprise: a front and back face; a plurality of side faces; and wherein the one or more channels are located along the front and/or back face.

In an embodiment, the one or more arms are orientated such that the front face is orientated along a horizontal plane.

In an embodiment, the one or more arms are orientated such that the front face is orientated along a vertical plane.

In an embodiment, the one or more arms are orientated such that the front face is perpendicular to the central body.

In an embodiment, the device and the at least one other device are arranged such that the one or more channels of the device and one or more channels of the other device are aligned.

In an embodiment, the bonding material is a composite or acrylic resin.

In an embodiment, the device further comprises an extended portion extending from the one or more arms towards the central body.

In an embodiment, the device is scanned by an intraoral scanner.

In an embodiment, at least one of the one or more arms are at an elevated angle.

In an embodiment, the device is primarily formed of at least one of the following: Poly (methyl methacrylate), titanium or peek.

In a second aspect of the invention, there is provided a method for determining the position of the at least one dental implant in a patient's mouth, comprising: attaching the device to one or more of the at least one dental implant defining attached devices; orientating the attached devices such that the one or more arms of the attached devices are between 0.1 mm-4 mm apart; bonding the attached devices; scanning the patient's mouth including the attached devices and visible gum to obtain scan data for use in determining the position of the at least one dental implant; removing the attached devices; and scanning the patient's mouth and recording positional data of the at least one dental implant.

In an embodiment, scanning the patient's mouth comprises moving a scanner left from a centre of the attached devices until a left end of the attached devices is reached, and moving the scanner right from the left end until a right end of the attached devices is reached.

In a third aspect of the invention, there is provided a kit comprising a plurality of devices including devices with one arm and devices with two arms.

### BRIEF DESCRIPTION OF THE ACCOMPANYING DRAWINGS

Embodiments of the present invention will now be described, by way of example only, with reference to the accompanying drawings, in which:

FIG. 1 is a front perspective view of a device in accordance with an embodiment of the invention;

FIG. 2 is a front perspective view of a central body of the device of FIG. 1;

FIG. 3 is a front perspective view of a collar and first arm of the device of FIG. 1;

FIG. 4 is a front perspective view of an alternate embodiment of the invention;

FIG. 5 is a top perspective view of multiple devices bonded together;

FIG. 6 is a front perspective view of an alternate embodiment of the invention; and

FIG. 7 is a front perspective view of an alternate embodiment of the invention.

### DETAILED DESCRIPTION OF EXEMPLARY EMBODIMENTS OF THE INVENTION

Embodiments of the invention described herein relate to a device for use in determining the position (location and/or orientation) of at least one dental implant, the device comprising a central body with an attachment portion adapted to attach to the dental implant. One or more arms extend away from the central body of the device and are adapted to bond to at least one other device. In particular, the one or more arms of the device bond to the central body and/or one or more arms of another device.

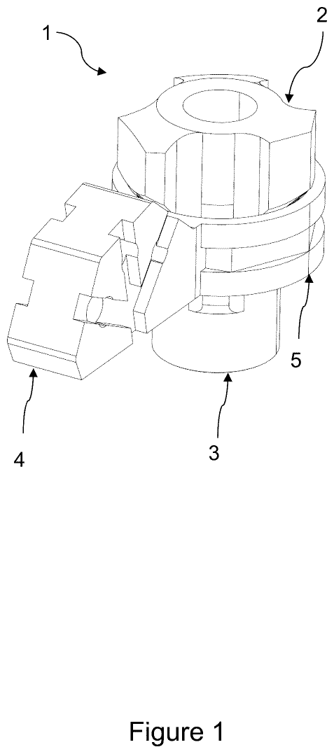

FIG. 1 is a front perspective view of an embodiment of the invention. In particular, a device (1) for use in determining the position of a dental implant, wherein the device comprises a central body (2) and an attachment portion (3). The attachment portion (3) is adapted to attach to a dental implant in the jaw of a patient. The central body (2) removably receives a first arm (4) that extends away from the central body (2). In particular, the first arm (4) is slidingly received by the central body (2) by way of a collar (5). In use, the first arm (4) of the device (1) is adapted to bond to a central body or arm of another device.

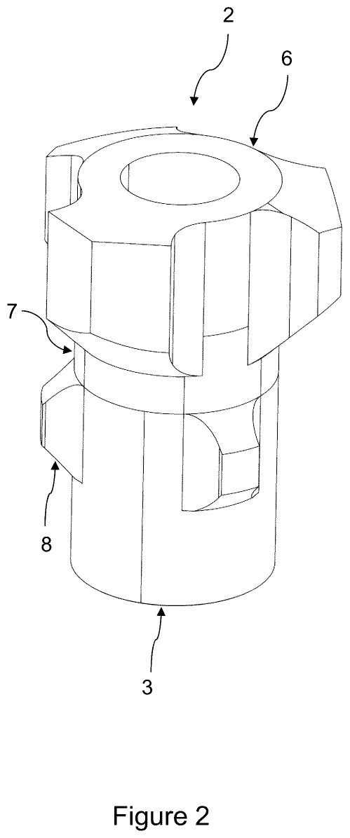

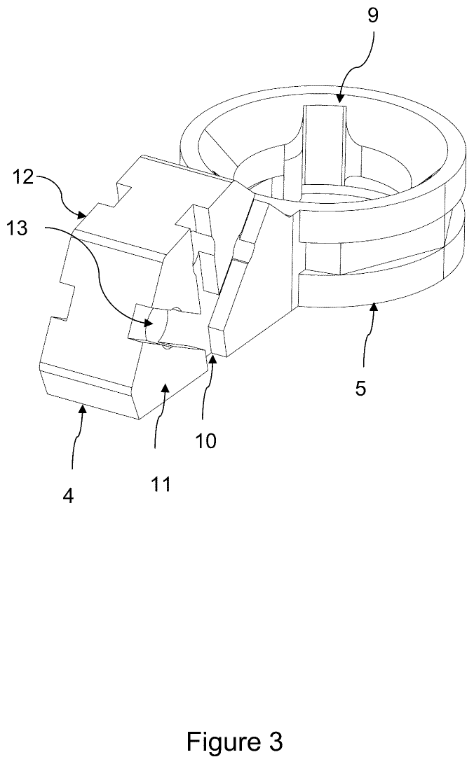

FIGS. 2 and 3 are front perspective views of the central body (2) and first arm (4) with collar (5) of the device (1) of FIG. 1 respectively.

The central body (2) of FIG. 2 comprises an attachment portion (3) for attachment to a dental implant. The dental implant may or may not include any adaptors that are located on the dental implant for which the attachment portion is able to attach. The central body (2) further comprises a head (6) with an opening which is adapted to receive a screw to further secure the device (1) to the dental implant. The head (6) is shaped such that it may be received by a complimentary tool if required. In the described embodiment, the head (6) is shaped with an incongruous geometry such that the orientation of the head (6) can be easily recognised by the intraoral scanner. In particular, the head (6) is comprised of a central opening for the screw, and three projecting portions, with two identical bevelled projecting portions, and one pentagonal projecting portion with no bevel. These projecting portions are shaped such that the gaps between the portions are able to partially receive a portion of the projecting portions of another central body piece, which is particularly useful if the dental implants are installed closely within the mouth. In an alternate embodiment, the projecting portions may take any shape such that they do not depart from the nature of the invention, in particular if the shapes are recognised by scanning technology.

An arm receiving portion (7) is located below the head (6) along the central body (2). One or more projections (8) are located along the central body (2) below the arm receiving portion (7) such that the collar (5) with the first arm (4) is able to be slidingly received by the central body (2) before the device is inserted onto a dental implant.

The first arm (4) of FIG. 3 extends from the collar (5). The collar (5) comprises a number of depressions (9) which are complementary to the one or more projections (8) of the central body (2). One or more channels (10) located on the first arm (4) are adapted to receive a bonding material to bond the first arm (4) with at least one other device. The one or more channels (10) may be any shape, depth or direction, and may intersect or may not intersect. The one or more channels (10) are located on a front face (11) of the first arm (4), as well as on the back face (12) of the first arm (4). The one or more channels (10) extend along the one or more arms until they reach at least of one of the side faces of the first arm (4) such that the channel is open at the respective side face of the first arm (4). Further, a number of holes (13) are located on the first arm (4) to allow the bonding material to enter and thoroughly secure to the first arm (4). The first arm (4) extends perpendicular from the collar (5), in turn being perpendicular to the central body (2) when received. A person skilled in the art would appreciate that the first arm (4) may extend from the collar at any angle such that it is able to bond to another device.

Using the central body (2) of FIG. 2 and first arm (4) and collar (5) of FIG. 3, the device (1) of FIG. 1 is formed by sliding the collar (5) of the first arm (4) onto the central body (2) from the attachment portion (3). Once the attachment portion (3) is received into the collar (5), the collar (5) continues along the central body (2) towards the head (6). The depressions (9) in the collar (5) are complimentary to the projections (8) of the central body (2), and as such, when the depressions (9) and projections (8) are aligned, the collar (5) is able to continue along the central body (2) until it terminates at the arm receiving portion (7) below the head (6). The collar (5) can then be rotated such that the depressions (9) and projections (8) are no longer aligned, and the collar (5) is secured to the central body (2) such that it cannot be slidingly removed without additional rotation.

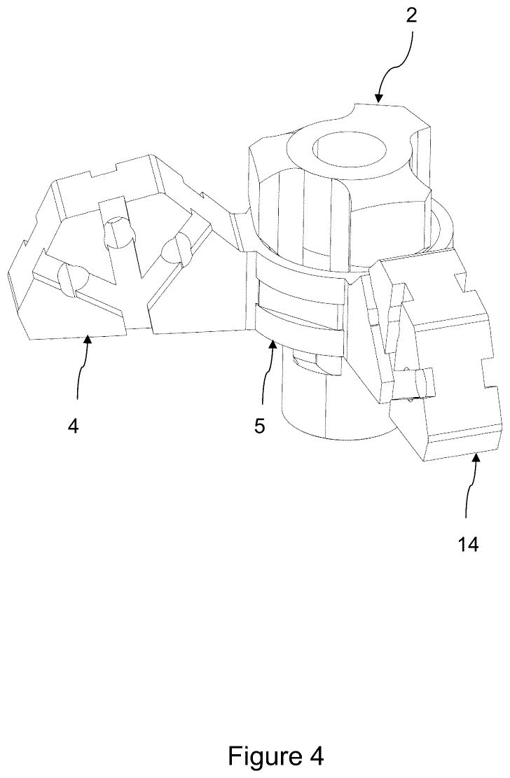

FIG. 4 is a front perspective view of an alternate embodiment of a device in accordance with an embodiment of the invention wherein the central body (2) of FIG. 2 is used with a collar (5) with a first arm (4) and a second arm (14). The device may have any number of arms extending from the collar (5) in any number of angles and orientations such that it does not depart from the nature of invention. The use of the arms is at the discretion of the practitioner. For example, a device (1) with only a first arm (4) is particularly useful where an oral landmark precludes the use of a device with more than one arm, or where the patient's mouth is particularly small, whereas a device with a first arm (4) and a second arm (14) is useful for larger adult jaws.

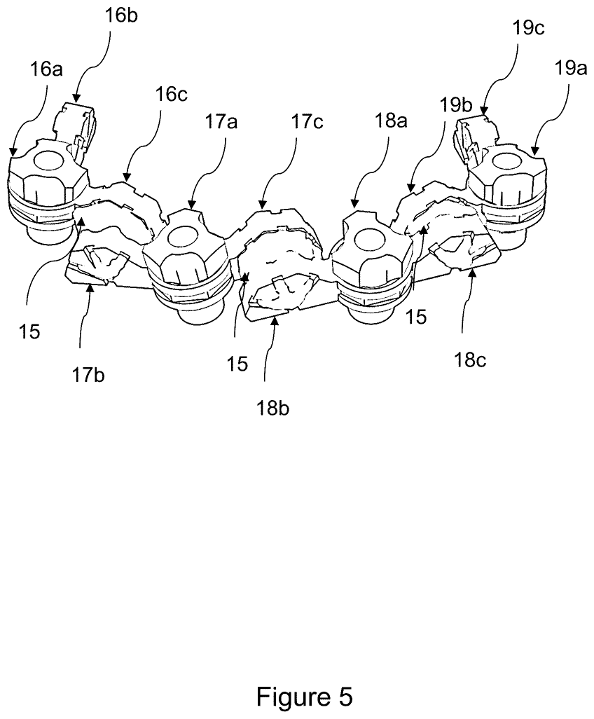

FIG. 5 is a top perspective view of a number of embodiments of the device bonded together using a bonding material (15). Typically, the devices are bonded after their insertion onto the dental implants in the mouth of a patient. In particular, FIG. 5 depicts a first device (16a), a second device (17a), a third device (18a), and a fourth device (19a) bonded together with a bonding material (15), such as a bonding resin. Each device (16a, 17a, 18a, 19a) comprises a central body and a first arm (16b, 17b, 18b, 19b) and second arm (16c. 17c, 18c. 19c). The first device (16a) is bonded to the second device (17a) by way of the bonding material (15) being sandwiched between the second arm (16c) of the first device (16a) and the first arm (17b) of the second device (17a). The second device (17a) is then bonded to the third device (18a) by way of the bonding material (15) being sandwiched between the second arm (17c) of the second device (17a) and the first arm (18b) of the third device (18a). The third device (18a) is then bonded to the fourth device (19a) by way of the bonding material (15) being sandwiched between the second arm (18c) of the third device (18a) and the first arm (19b) of the third fourth (19a). The first arm (16b) of the first device (16a) and second arm (19c) of the fourth device (19a) are not bonded to another arm, or a central body (2), but are adapted to be bonded to a central body (2) or arm if required.

Once the devices (16a, 17a, 18a, 19a) are bonded, they are scanned to obtain a digital dental impression which can be used to ascertain the position of the oral implants within the patient's mouth. Advantageously, as the devices (16a, 17a, 18a, 19a) are bonded together rather than simply seated on the dental implants, they are less likely to move in the event the patient is bumped, for example by the intraoral scanner during patient record capture, thereby ensuring the integrity of the scan and mitigating the need for an additional scan.

Further, as the bonded devices are seated within the mouth removably (i.e. may passively be seated on the dental implant, or may be removably screwed into the dental implant using the opening in the head (6) of the central body (2)), they remove the need for a verification jig to be created as the position of the implants are verified by the bonded devices (16a, 17a, 18a, 19a). In an exemplary embodiment, the bonded devices (16a, 17a, 18a, 19a) as well as the intraoral scan(s) are sent to a laboratory where a model of the patient's mouth is created. The bonded devices are then placed onto the pre-prepared model of the patient's mouth and if they sit passively on the model of the patient's mouth, the intraoral scan(s) are considered verified and ready for the next stage of prosthetic fabrication. This decreases the number of visits that are required by the patient with the practitioner, as well as decreases the amount of materials and time required to create the dental prosthetic from the positional data obtained on the dental implants.

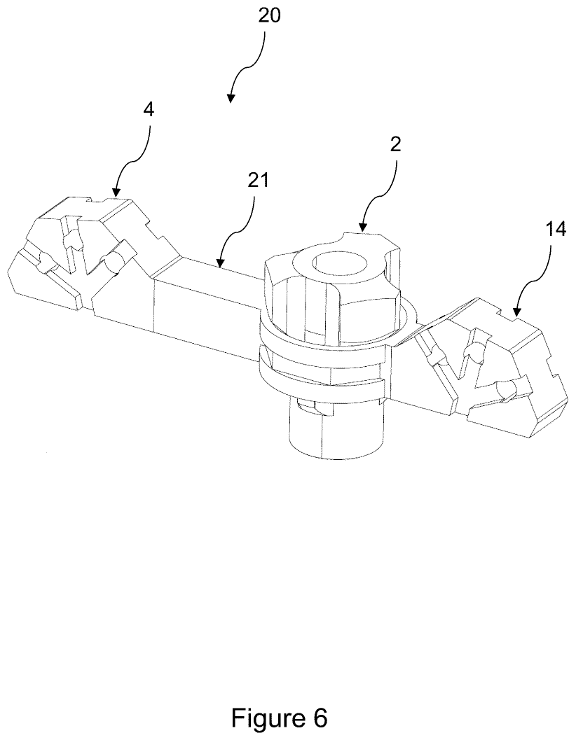

FIG. 6 is a front perspective view of an alternate embodiment of the invention wherein a device (20) comprises a central body (2), a first arm (4) and second arm (14). The first arm (4) is comprised of an extended portion (21) which extends the distance between the central body (2) and the first arm (4). In further embodiments, the device may comprise only a first arm (4) with an extended portion (21) or may comprise more than one arm with an extended portion (21). The extended first arm (21) allows for larger spaces between dental implants (in larger jaws) without sacrificing the possibility of binding the device to at least one other device.

By way of example only, a method for determining the position of four dental implants to create a dental prosthesis using the devices (16a, 17a, 18a, 19a) of FIG. 6 is described. The method comprises the steps of firstly the practitioner observing the devices best suited for the dental implants, in particular focusing on the desired number or arms, desired height and desired angle of the arms. The practitioner couples the central body (2) with the desired collar (5) having one or more arms. In particular, the practitioner slidingly receives the collar (5) onto the central body (2) until the collar (5) reaches the projections (8) of the central body (2). The practitioner then attaches the central body (2) to the dental implant via the attachment means (3). The practitioner repeats this step for each dental implant, optionally inserting a screw into the central body (2) to further secure the central body (2) to the dental implant. In an embodiment, the practitioner may deduce that no arm is suitable, and only the central body (2) is attached via the attachment means (3) to the dental implant. This lone central body (2) is adapted to bond to a central body or one or more arms of another device. Once the practitioner is satisfied that at least one arm or central body of each device is able to bond with another device, the practitioner aligns the projections of the central body (2) with the depressions (9) of the collar (5) by rotating the head (6) of the central body (2). This rotation aligns the depressions (9) of the collar (5) and the projections (8) of the central body (2) which allows the collar (5) to move along the central body (2) to the arm receiving portion (7).

The devices (16a, 17a, 18a, 19a) should be located such that the arms are between 0.1 mm-10 mm (millimetres) apart, or more preferably, between 0.1 mm-4 mm (millimetres) apart. The practitioner then bonds the devices (16a, 17a, 18a, 19a) using a bonding material (15) such as composite resin. Depending on the bonding material (15), the material (15) may need to be cured.

A scan of the bonded devices (16a, 17a, 18a, 19a) as well as the surrounding visible gum is obtained using an intraoral scanner. Typically, practitioners scan a jaw using an intraoral scanner starting from the back left of the jaw and moving to the right of the jaw. They first use this motion to scan soft tissue, and repeat this motion to scan teeth, dental implants, and in this embodiment, dental devices. While this scanning technique is suitable to gain positional data on the dental implants and devices, a practitioner may adopt a superior technique which reduces inaccuracies in a scan by alternatively scanning the devices and dental implants from the center of the jaw, moving left, coming back to the center, and then moving right, and repeating this motion to scan the soft tissue. Once the scan is obtained, it is locked, copied and cropped to only render an image of the dental device and dental implants. The bonded dental devices are then removed, and a final scan is obtained of only the dental implants and soft tissue, using either the typical scanning technique, or the superior technique. The final scans are overlaid and positional data of the dental implants is obtained which will be used to create a dental prosthetic.

In an alternate embodiment of the method described above, a scan is performed before attaching the dental devices onto the dental implants. The scan and relevant data are sent to an application. The application may be a computer application (computer software) accessible on a computer, mobile, tablet or the like. The application determines the best device for each implant by determining the best device characteristics for each dental implant. The desired device characteristics that are determined can include, but are not limited to, the desired height, size, number of arms and angle of arms of the device which removes the practitioner using their discretion to which devices types to use.

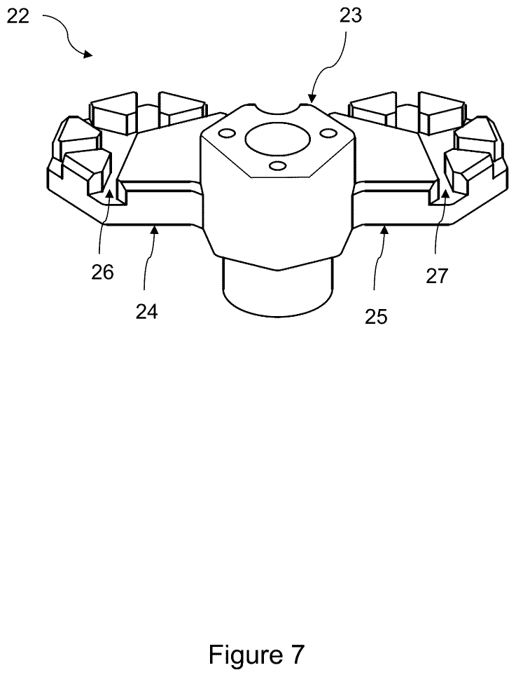

FIG. 7 is a front perspective view of an alternate embodiment of the invention wherein the one or more arms of the device (22) are not removable. In particular, the device (22) comprises a central body (23), a first arm (24) and second arm (25) projecting from the central body (22). The first arm (24) and second arm (25) have a plurality of respective channels (26, 27) adapted to receive a bonding material. In use, the devices (22) are attached to the dental implant and arranged such that at least one channel of a first device is aligned with at least one channel of a second device to allow the bonding material to flow between the channels to form a bridge. The bridge links the first and second device, thereby bonding the first and second device. The device (22) in the described embodiment may further comprise an x-ray visible collar (i.e. titanium collar) adapted to be received by the central body (23) such that when an x-ray is taken, the central body location (23) can be ascertained.

An embodiment of the invention may be sold as a kit which contains a plurality of devices including devices with a single arm and devices with a pair of arms. The kit may further comprise devices of at least two different heights, and devices with angled arms and horizontally planar arms. The kit allows for practitioners to be prepared for any jaw shape. The kit may further comprise devices with three arms.

In an embodiment of the invention the attachment portion (3) is a primarily hollow cavity. The primarily hollow cavity is adapted to receive a portion of an oral implant such that the central body (2) becomes seated on the oral implant. A primarily hollow cavity attachment means is particularly useful in instances where the oral implant is a removable overdenture oral implant. Further, in use a hollow cavity allows for a quick click-on-click-off technique to be utilized when seating the device (1) on the oral implant. The cavity may be opened, or may be closed. It should be appreciated that the attachment portion may be comprised of any attachment means wherein the device is able to be attached to the oral implant. This includes but is not limited to, a threaded portion, a hollow cavity, etc.

A person skilled in the art would appreciate that the arms of the device may project along the horizontally plane, vertical plane, or may project at an elevated or depressed angle. When the arms are located such that the front face is predominantly perpendicular to the central body, there is a decreased amount of shrinkage when bonding with the resin.

The bonding material may be any material that is able to bond one device to another device. Non-limiting examples include composite and acrylic resins.

The collar and one or more arms are primarily formed of Poly(methyl methacrylate) (PMMA), metal (i.e. titanium), plastic or peek, but may be primarily formed of any material that is safe for use. The central body is primarily formed of metal, such as titanium which can be readily visible in an x-ray.

A person skilled in the art would appreciate there are numerous uses for the device that do not depart from the invention, including but not limited to obtaining implant information to create dental restorations (fixed or removable prosthetics) and dental models which can be used for a range of purposes.

The arms of the device can be any shape, such as heptagonal prisms which are a unique shape that is easy to scan and record with an intraoral scanner. Further, heptagonal prisms are shaped such that they are able to avoid oral landmarks and fit the contours and curves of the maxilla and mandible making their placement more accurate. A person skilled in the art would appreciate that the arms do not always take the shape of a heptagonal prism, and may instead be a hexagonal prism, pentagonal prism, rectangular, circular, square, or any shape such that they do not depart from the nature of the invention and are able to be joined to another device. The arms of the device may have an incongruous geometry.

The device may be any height such that it is able to fit within the mouth of a patient. For example, the device may be between 3 mm and 15 mm, more preferably, between 6 mm and 9 mm.

In an embodiment, the one or more channels (10) may be located on the front face of the one or more arms, or may be located on the back face of one or more arms. In an alternate embodiment, the one or more channels (10) may be located on the front and back face of the one or more arms. In an embodiment, the one or more arms do not have one or more channels (10). The one or more arms may also have holes (13) which receive the bonding resin, however alternate embodiments of the invention may not have holes (13).

A person skilled in the art would appreciate the central body (2) and collar (5) may be attached in a number of manners which do not depart from the nature of the invention. For example, the central body (2) may have grooves while the collar (5) may have projections, or vice versa. Alternatively, the central body (2) and collar (5) may be threading received, or received via a friction fit. In further embodiments, the central body (2) and collar (5) and/or one or more arms may be bonded together to form a unitary piece.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments.

Further, each independent feature or component of any given assembly may constitute an additional embodiment.

1. A device for use in determining a position of at least one dental implant, the device comprising:
a central body with an attachment portion adapted to attach to the dental implant;
one or more arms extending away from the central body; and
wherein the one or more arms are adapted to bond to at least one other device.

2. The device as in claim 1, wherein the central body removably receives the one or more arms.

3. The device as in claim 2, wherein the one or more arms are received by the central body by way of a collar from which the one or more arms extend.

4. The device as in claim 1, wherein at least one of the one or more arms of the device bond to the at least one other device central body or one or more arms.

5. The device as in claim 1, further comprising:
one or more channels located on the one or more arms; and
wherein a bonding material is adapted to be received in the one or more channels to bond at least one of the one or more arms of the device to the at least one other device.

6. The device as in claim 5, further comprising one or more holes on at least one of the one or more arms.

7. The device as in claim 5, wherein the one or more arms comprise:
a front and back face;
a plurality of side faces; and
wherein the one or more channels are located along the front and/or back face.

8. The device as in claim 7, wherein the one or more arms are orientated such that the front face is orientated along a horizontal plane.

9. The device as in claim 7, wherein the one or more arms are orientated such that the front face is orientated along a vertical plane.

10. The device as in claim 9, wherein the one or more arms are orientated such that the front face is perpendicular to the central body.

11. The device as in claim 5, wherein the device and the at least one other device are arranged such that the one or more channels of the device and one or more channels of the other device are aligned.

12. The device as in claim 5, wherein the bonding material is a composite or acrylic resin.

13. The device as in claim 5, wherein the device further comprises an extended portion extending from the one or more arms towards the central body.

14. The device as in claim 1, wherein the device is scanned by an intraoral scanner.

15. The device as in claim 1, wherein at least one of the one or more arms are at an elevated angle.

16. The device as in claim 1, wherein the device is primarily formed of at least one of the following: Poly(methyl methacrylate), titanium or peek.

17. A method for determining the position of the at least one dental implant in a patient's mouth, comprising:
attaching the device of claim 1 to one or more of the at least one dental implant defining attached devices;
orientating the attached devices such that the one or more arms of the attached devices are between 0.1 mm-4 mm apart;
bonding the attached devices;
scanning the patient's mouth including the attached devices and visible gum to obtain scan data for use in determining the position of the at least one dental implant;
removing the attached devices; and
scanning the patient's mouth and recording positional data of the at least one dental implant.

18. The method of claim 17, wherein the scanning the patient's mouth comprises:
moving a scanner left from a centre of the attached devices until a left end of the attached devices is reached; and
moving the scanner right from the left end until a right end of the attached devices is reached.

19. A kit comprising:
a plurality of devices as in claim 1 including devices with one arm and devices with two arms.
